(19) United States
(12) Patent Application Publication
(10) Pub. No.: US 2008/0235315 A1
(43) Pub. Date: Sep. 25, 2008

(54) TECHNIQUE FOR SOLVING NP-HARD PROBLEMS USING POLYNOMIAL SEQUENTIAL TIME AND POLYLOGARITHMIC PARALLEL TIME

(76) Inventor: Javaid Aslam, Sanata Clara, CA (US)

Correspondence Address: JAVAID ASLAM, 810 TRANSILL CIRCLE, SANTA CLARA, CA, 95054, US

(21) Appl. No.: 11/865,075

(22) Filed: Oct. 1, 2007

Related U.S. Application Data
(60) Provisional application No. 60/827,719, filed on Oct. 1, 2006.

(51) Int. Cl. G06F 17/11

(52) U.S. Cl. 708/446

(57) ABSTRACT

A system and technique, called Solution Enumeration technique, for finding efficient algorithms for NP-hard combinatorial problems is presented. The solution space of these problems grows exponentially with the problem size. Some examples in this class are: Hamiltonian Circuit, SAT, Graph Isomorphism, and Perfect Matching problems. The core of this technique is a graph theoretical model of an NP-hard problem, viz., counting the perfect matchings in a bipartite graph. This technique is then applied to develop deterministic algorithms using polynomial sequential time or polylogarithmic parallel time (for massively parallel computers) for the search and counting associated with all NP-complete problems. In the past no polynomial time algorithms for these problems were found, and thus are believed to be intractable. This invention thus makes a theoretical as well as practical contribution to the field of computing, and has practical applications in many diverse areas.

### CROSS-REFERENCE TO RELATED APPLICATION

This patent application claims priority from Provisional Patent Application, Ser. No. 60/827,719 filed Oct. 1, 2006 for “A System and Technique for Efficiently Solving Hard Search and Counting Problems, including, Perfect Matching, Hamiltonian Circuit, SAT and Graph Isomorphism, using Sequential as well as Parallel (NC) Algorithms”. The essential contents are taken from that application with appropriate reference.

### BACKGROUND OF THE INVENTION

1. Field of the Invention

Computer methods and algorithms for solving intractable (NP-hard and NP-complete) combinatorial problems.

2. Prior Art

The time complexity of a computer method for a given problem is a mathematical function correlating the execution time and the size of the given problem. For many optimization problems the time complexity of any known solution, i.e., any algorithm, is exponential in the problem size, i.e., it grows exponentially with the size of the input data. Such problems are called intractable, and more formally they have been put in certain classes called NP-complete and NP-hard or #P-complete problems.

The importance of the execution time of an algorithm lies in the scalability of an optimal solution when the problem size can grow very large. For instance, 100% validation of the combinational logic circuits in large VLSI chips is practically not formidable. The related theoretical problem is commonly known as SAT (for satisfiability) [GJ79], and is the very first identified NP-complete problem. There are many other real-life NP-complete and NP-hard problems such as Multiprocessor scheduling, Traveling Salesman and VLSI layout, to name a few, which prohibit finding an optimal solution.

To the best of the inventor's knowledge, no patented or published result is known to have devised a method for solving the intractable optimization problems in polynomial time. Many attempts have been made to circumvent theses problems by either using some heuristics or special cases where an approximation of the optimal solution can be obtained with pragmatic resource bounds. The U.S. Pat. No. 6,556,978, “Satisfiability algorithms and finite quantification”, is one such example.

Among such hard problems there is one very intriguing problem, i.e., the counting problem for perfect matching in a bipartite graph, which is known to be #P-complete [Val79], i.e. at least as hard as any NP-complete problem, even though the corresponding search problem has long known to be solvable in polynomial time, i.e., it is in [symbol] [Edm65]. One of the aspects of this problem is that no parallel algorithm for the search problem (finding any perfect matching) has been found so far.

The class of problems that can achieve ploylogarithmic time bound with polynomially many processors are are said to be in class called NC [Pip79]. Although perfect matching problem for certain restricted graphs has been found to be in NC (see for instance, [MV00, DHK93], [GK87, KVV85, GLV81]), the general search problem for any bipartite graph has remained open, i.e., not known to be in NC. Similarly, no polynomial time algorithm has been found to date for the general (search) problem of graph isomorphism [AV00, KST92, Hof82].

The techniques described here show how to solve all such intractable problems not only in sequential time but also in parallel time by using a suitable NC algorithm. These techniques are based on a group theoretic concept, called, the generating set of a permutation group. Most of the claims have been taken from the PPA [Asl06b] and an unpublished work of the inventor [Asl06a].

3. Objects and Advantages

This invention provides a new framework for solving a large class of intractable problems by a single as well as massively parallel processors to achieve polynomial sequential and polylogarithmic parallel time. Such a solution is not even believed to exist. An indirect implication of this invention would be a very large incentive for integrating very large number of processors on one VLSI chip or on one board, and also incentives for creating many application specific IC's (ASIC).

### REFERENCES

[Asl06a] Javaid Aslam, A Permutation Algebra for Solving Hard Search & Counting Problems—an unpublished report, 2006.
[Asl06b] ______, A System and Technique for Efficiently Solving Hard Search and Counting Problems, including, Perfect Matching, Hamiltonian Circuit, SAT and Graph Isomorphism, using Sequential as well as Parallel (NC) Algorithms, application 60/827,719, Oct. 1, 2006.
[AV00] V. Arvind and N. V. Vinodchandran, The Counting Complexity of Group-definable Languages, Theoretical Computer Science 242 (2000), no. 1-2, 199-218.
[DHK93] Elias Dahlhaus, Péter Hajnal, and Marek Karpinski, On the Parallel Complexity of Hamiltonian Cycle and Matching Problem on Dense Graphs, J. Algorithms 15 (1993), no. 3, 367 384.
[Edm65] Jack Edmonds, Paths, Trees, and Flowers, Canadian Journal of Mathematics 17 (1965), 449-467.
[GJ79] M. Garey and D. S. Johnson, Computers and Intractability: A Guide to the Theory of NP-Completeness, W. H. Freeman & Co., San Francisco, Calif., 1979.
[GK87] D. Grigoriev and M. Karpinski, The Matching Problem for Bipartite Graphs with Polynomially Bounded Permanents is in NC, Proceedings 28th Annual Symp. on Foundations of Computer Science, 1987, pp. 166-172.
[GLV81] N. Pippenger G. Lev and L. Valiant, Algorithm for Routing in Permutation Networks, IEEE Trans on Computers C-30 (1981), 93-100.
[Hof82] C. M. Hoffmann, Group-theoretic Algorithms and Graph Isomorphism, Lecture Notes in Computer Science, vol. 136, ch. II, Springer-Verlag, Berlin, 1982.
[KST92] Johannes Köbler, Uwe Schöning, and Jacobo Torán, Graph Isomorphism is Low for PP, Computational Complexity 2 (1992), no. 4, 301-330.
[KVV85] Dexter Kozen, Umesh V. Vazirani, and Vijay V. Vazirani, NC Algorithms for Comparability Graphs, Interval Gaphs, and Testing for Unique Perfect Matching, Proceedings of the Fifth Conference on Foundations of Software Technology and Theoretical Computer Science, Springer-Verlag, 1985, pp. 496-503.
[MV00] Meena Mahajan and Kasturi R. Varadarajan, A New NC-Algorithm for Finding a Perfect Matching in Bipartite Planar and Small Genus Graphs (Extended Abstract), Proceedings of the 32nd annual ACM symposium on Theory of computing, ACM Press, 2000, pp. 351-357.
[Pip79] N. J. Pippenger, On Simultaneous Resource Bounds, Proceedings of the 20th Annual Symposium on Foundations of Computer Science, October 1979, pp. 307-311.
[Val79] L. G. Valiant, The Complexity of Computing the Permanent, Theoretical Computer Science 8 (1979), 189-201.

### BRIEF SUMMARY

A system and technique for finding efficient solutions for intractable combinatorial optimization problems is presented. The core of this technique is a graph theoretical model of an NP-hard problem, viz., counting all the perfect matchings in a bipartite graph. To solve any combinatorial problem efficiently a transformation to this problem is required. Two such transformations are provided here, and many others can be derived from the existing prior art. In the past no polynomial time algorithms for these problems were found. This invention thus makes a theoretical as well as practical contribution to the field of computing, and has practical applications in many diverse areas.

### DRAWINGS—A BRIEF DESCRIPTION

FIG. 1 shows a complete Bipartite Graph, K_{4,4}, on 8 nodes.

FIG. 2 shows the Edge Pairs Exhibiting the Relation R in a bipartite graph.

FIG. 3 shows the Generating Graph Γ(4) for K_{4,4}.

FIG. 4 shows the role of Edge Requirements in Perfect Matching Composition by an R-path.

FIG. 5 shows disjoint Multiplication using mdags.

FIG. 6(a) shows how to join and count various VMPs between two nodes. FIG. 6(b) shows the structure of the associated matrices that represent the VMPs at various stages in computation.

FIG. 7 shows a solution to Graph Isomorphism using CVMP.

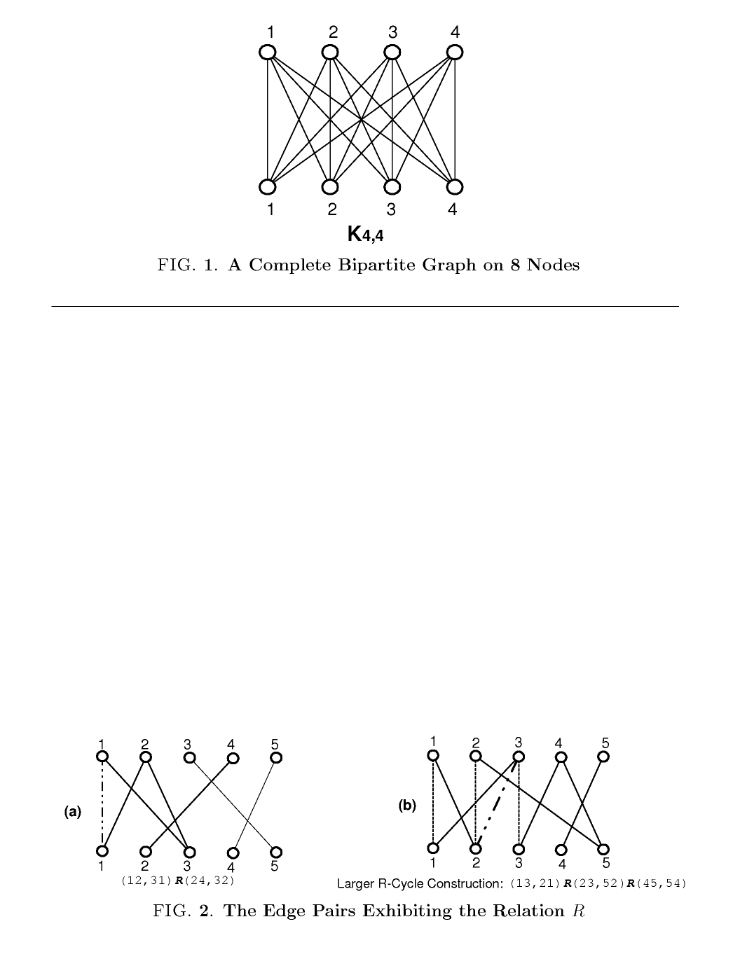

### 3. DETAILED DESCRIPTION

### 3.1. Theory of Operation

The core component of this Solution Generating system is a generating graph which is the foundation for allowing search and counting of all NP-complete and many NP-hard problems in polynomial sequential time and polylogarithmic parallel time. It is based on the concept of a generating set in Permutation Group theory, allowing all the perfect matchings in a bipartite graph to be enumerated in polynomial time. We first present the associated concepts and the construction of a generating graph.

### 3.2. Perfect Matchings & the Permutation Group

Let G be a permutation group on n! permutations of the set Ω={1, 2, . . . , n}. Within the scope of the perfect matching problem we will assume the permutation group G=Sₙ. Let Π be a subgroup of G, denoted as Π<G. Then ∀g ε G the set H·g−h{h·g\h ε H} is called a right coset of H in G. A permutation group G can be partitioned into disjoint subsets using the right cosets of H as:

$$G = {{⊎}^{r}}_{i - 1} H \cdot {g}_{i} \qquad ( 3.1 )$$

The elements in the set {g₁, g₂, . . . , gᵣ} are called the right coset representatives (also a complete right traversal) of H in G.

Let G⁽ⁱ⁾ be a subgroup of G obtained from G=Sₙ by fixing all the points in {1, 2, . . . , i}. That is, for each π ε G⁽ⁱ⁾, and ∀j ε {1, 2, . . . , i}; j^{π}−j. Then it is easy to see that G⁽ⁱ⁾<G⁽ⁱ⁻¹⁾, where 1≦i≦n and G⁽⁰⁾=G.

3.3. The Group Generating Set. The sequence of subgroups

I−G⁽ⁿ⁾<G⁽ⁿ⁻¹⁾< . . . <G⁽¹⁾<G⁽⁰⁾−G (3.2)

is referred to as a subgroup tower or a stabilizer chain of G [Hof82].

A generating set of a permutation group G is defined to be the set of permutations, say K, such that all the elements in G can be written as a finite product of the elements in K. The subgroup tower in (3.2) gives rise to a generating set given by the following Theorem [Hof82].

Theorem 3.1. Let Uᵢ be the set of right coset representatives of G⁽ⁱ⁾ in G⁽ⁱ⁻¹⁾, 1≦i≦n. Then a generating set K of the group G is given by

$$K {=}^{def} {⋃}_{i = 1}^{n} {U}_{i} \qquad ( 3.3 )$$

These generating sets are not unique, and the one we are interested in is derived from those coset representatives that are transpositions (except for the identity), i.e., for Sₙ, the coset representatives are

Uᵢ−{I, (i, i+1), (i, i+2), . . . , (i, n)}, 1≦i<n. (3.4)

Then the generating set of Sₙ is given by

∪Uᵢ={I, (1, 2), (1, 3), . . . , (1, n), (2, 3), (2, 4), . . . , (2, n), . . . , (n−1, n)} (3.5)

A permutation π₁ ε G⁽ⁱ⁻¹⁾ can then be computed from another given permutation π ε G⁽ⁱ⁾ as

π₁=πψᵢ, ψᵢ ε Uᵢ, 1≦i≦n (3.6)

Each permutation π ε Sₙ can be uniquely constructed from the generators of Sₙ as:

π−ψₙψₙ₋₁ . . . ψ₂ψ₁; (3.7)

where ψᵢ ε Uᵢ, 1≦i ≦n .

Let BG=K_{n,n}=(V ∪ W, E) be a complete bipartite graph on 2n nodes, and let its both the node sets V and W be labelled from Ω={1, 2, . . . , n} in the same order. Under such an ordering, the node pair (vᵢ ε V, wᵢ ε W) will sometime also be referred to as simply the node pair at position i in BG.

A perfect matching in BG is a subset of edges E′={(v, w)} ⊂ E such that ∃π ε G such that ∀(v, w) ε E′, v^{π}−w. Let E(π) denote the set of edges in BG representing the perfect matching that realizes the permutation π ε G.

We will use the above generating set concepts in developing a combinatorial structure for generating the perfect matchings in a bipartite graph.

Let [symbol] (BG) denote the set of permutations realized as perfect matchings in BG.

Since BG=K_{n,n}, ∀ π ε G and ∀ v ε V, there exists a pair (v, w) such that v^{π}=w [symbol] vw ε E(π) ε BG. Hence M(BG)=Sₙ. The perfect matching realizing the identity permutation I will be referred to as the identity matching denoted by E(I).

Let BGᵢ denote the sub (bipartite) graph of BG=K_{n,n} induced by the subgroup G⁽ⁱ⁾ such that all the permutations realized (as perfect matchings) by BGᵢ fix the points in {1, 2, . . . , i}. That is, there is exactly one edge vₜwₜ incident on the nodes vₜ and wₜ, 1≦t≦i. Moreover, BGᵢ contains a complete bipartite graph, K_{n-i,n-i}, on nodes i+1, i+2, . . . , n. That is, now we have [symbol] (BGᵢ)=G⁽ⁱ⁾.

3.4. Perfect Matching Generators. We now develop a system of generators of perfect matchings in a complete bipartite graph, similar to the generators of a permutation group. Later we will show that the same generator can be used for any arbitrary bipartite graph.

The following Theorem and it Corollary 3.3 captures the essential behavior of permutation multiplication and hence form the basis of perfect matching generators.

### Multiplication by a Transposition.

Theorem 3.2. Let π ε Sₙ be realized as a perfect matching E(π) by a bipartite graph BG′ on 2n nodes. Then for an transposition, ψ ε Sₙ, the product πψ is realized by BG′ iff BG′ contains a cycle of length 4 such that the two alternate edges in the cycle represent the multiplier ψ, and the other two are from the perfect matching E(π).

### Multiplication by a Coset Representative.

Corollary 3.3. Let BG=K_{n,n} be a complete bipartite graph. Then for each coset representative ψ of G⁽ⁱ⁾ in G⁽ⁱ⁻¹⁾ (except for the identity), where ψ=(i, k), i<k≦n, and for each π ε G⁽ⁱ⁾, πψ is realized by BGᵢ₋₁ if and only if
(1) there exists a unique edge pair aᵢ(π, ψ) (vᵢwₖ, vₜwᵢ) representing ψ such that i^{ψ}=k=t^{π},
(2) the product πψ ε G⁽ⁱ⁻¹⁾ covers the edge-pair aᵢ(π, ψ), and all other edges, except the edge vₜwₖ in E(π), remain unaffected in forming this product.

When the coset representative is an identity i.e., i^{ψ}=i, we have a special case of the above behavior where the edge pair aᵢ(π, ψ) reduces to one edge vᵢwᵢ for each π 68 G⁽ⁱ⁾.

A generating set for a bipartite graph K_{n,n} is a collection of its edge pairs determined by each (ψ, k^{π}^{^{−1}}) pair, where π ε G⁽ⁱ⁾, and ψ−(i, k) ε Uᵢ (3.4) is a right traversal (right coset representative) for G⁽ⁱ⁾ in G⁽ⁱ⁻¹⁾, 1≦i≦k≦n. (Corresponding to I ε Uᵢ, one distinguished edge pair, (vᵢwᵢ, vᵢwᵢ), will also be included.)

Let V and W node sets of K_{n,m} are labelled from {1, 2, . . . , n} in the same order. Then we define a set of edge pairs in K_{n,n} as follows:

$$g ( i ) {=}^{def} \{ ( ik , ji ) \vert i < j , k \leq n \} ⋃ \{ ( ii , ii ) \} . \qquad ( 3.8 )$$

Using the analogy from the Coset Representatives of a permutation group, we will call g(i) to be the edge pair representative for the subgraph BGᵢ induced by the subgroup, G⁽ⁱ⁾<G, which fixes all the points in {1, 2, . . . , i}.

Lemma 3.4. The edge pair representative, g(i), 1≦i≦n, implements all the right coset representatives in (3.4), viz., Uᵢ={I}∪{(i, k)|i<k≦n}, of the subgroup G⁽ⁱ⁾ in G⁽ⁱ⁻¹⁾, where each ψ=(i, k) ε Uᵢ (except the identity) is realized by a family of edge pairs, {(vᵢwₖ, vₜwᵢ)| π ε G⁽ⁱ⁾, i<n; t^{π}=k}. (Note: By convention, G⁽⁰⁾=G)

Definition 3.5. A generating set, denoted as E_{M}(n), for generating all the n! perfect matchings in a complete bipartite graph BG=K_{n,n} is defined as

$${E}_{M} ( n ) {=}^{def} {{⋃}^{n}}_{i = 1} g ( i ) . \qquad ( 3.9 )$$

3.5. A Transitive Relation on the Edge Pairs. We shall now formulate a relation R on the generating set E_{M}, and then prove R to be a transitive relation. The definition of R is based on Corollary 3.3. First we define some more terms.

Let π(aᵢ), aᵢ ε g(i) (3.8), represent a class of permutations defined as follows.

$$π ( {a}_{i} ) {=}^{def} π \vert π ∈ {G}^{( i - 1 )} and E ( π ) covers {a}_{i} . \qquad ( 3.10 )$$

For brevity we will often qualify a permutation π ε G as “π covers a set of edges e” whenever the corresponding perfect matching, E(π) in K_{n,n} covers e.

Let ψₐ_{ᵢ} denote the coset representative of G⁽ⁱ⁾ in G⁽ⁱ⁻¹⁾ realized by the edge pair aᵢ for some π ε G⁽ⁱ⁾ such that π(aᵢ)=πψₐ_{ᵢ} ε M(BG₍ᵢ₋₁₎).

Corresponding to the identity coset representative I ε Uᵢ we will call the edge pair (vᵢwᵢ, vᵢwᵢ) at node pair i as identity edge pair, denoted by idᵢ.

### R-Cycle: A Structure for the Relation R.

Definition 3.6. Let a=(vᵢwᵣ, vₛwᵢ) and b=(vⱼwₚ, v_{q}wⱼ) be the two edge pairs in a bipartite graph K_{n,n}, 1≦i<j≦n, at the node pairs i and j respectively. Let C_{ab} be a cycle in BG such that it covers the edge pair a, the edge vᵢwᵢ, some or all the node pairs (vₓ, wₓ), i≦x<j, and one of the edges (depends on a) in b,if b≠idⱼ (if b=idⱼ then the only edge vⱼwⱼ will be covered). Then C_{ab} is an R-cycle defined as follows:
(1) C_{ab} of length 4 is a cycle covering the nodes (vᵢ, wᵢ, vⱼ, wₚ) or (vᵢ, wᵢ, v_{q}, wⱼ), or (vᵢ, wᵢ, vⱼ, wⱼ).
(2) A larger cycle, C_{ab}, of length l+2 obtained from an R-cycle, C_{mb}, of length l≧4 as follows. └FIG. 2(b)┘
   Let Cₐₘ be an R-cycle of length l=4, where m ε g (k), i<k<j, is an edge pair in BG, and C_{mb} covers one of the edges from the pair b ε g(j). Let e ε m be an edge such that for some a ε g(i), a and e form an R-cycle, Cₐₘ, of length 4. Then the new cycle, C_{ab}, is obtained by merging the two cycles Cₐₘ and C_{mb} as follows. We can remove the edge e common to both the cycles, viz., Cₐₘ and C_{mb}. Then the larger cycle, C_{ab}, is an R-cycle of length l+2.

### The Transitive Relation R.

The following definition of the relation R specifies the condition under which two coset representatives, ψ(aᵢ) and ψ(bⱼ), corresponding to the two edge pairs aᵢ ε g(i) and bⱼ ε g(j), i<j, may be used in realizing the product, π(bⱼ)ψ(aᵢ) by the bipartite graph BG=K_{n,n}.

Definition 3.7. Two edge pairs aᵢ ε g(i) and bⱼ ε g(j), 1≦i<j≦n, at the node pairs i and j respectively, in a bipartite graph K_{n,n} are said to be related by a relation R, denoted as aᵢRbⱼ, if one of the following axioms is satisfied:
(1) If aᵢ=idᵢ (then aᵢRbⱼ for all bⱼ ε g(i+1)).
(2) If aᵢ≠idᵢ, there exists an R-cycle of length 4 in BG such that the cycle covers the edge pair aᵢ, and one of the edges (if bⱼ≠idⱼ) from the pair bⱼ, determined by aᵢ. If bⱼ−idⱼ, clearly the only available edge idⱼ will be covered.
(3) If there exists an edge pair m ε g(i+1) such that, (i) aᵢRm by (2), and (ii) mRbⱼ.

Note that the edge pairs belonging to the same edge representative g(i), 1≦i≦n, are not considered for the relation R. The following Theorem provides a group theoretic semantics for the relation R. It shows how the multiplication of permutations and the relation R are tied together.

Theorem 3.8. Let a ε g(i), b ε g(j) be the edge pairs at the nodes i and j respectively in BG=K_{n,n}, such that G^{(j)}<G⁽ⁱ⁾, 1≦i<j≦n. Let πₐ=ψⱼ₋₁ψⱼ₋₂ . . . ψᵢ₋₁ψᵢ, where ψᵣ ε Uᵣ, i≦r≦j−1 and ψᵢ=ψₐ. Let aRb be realized by the transitivity of the intermediate nodes such that ∀i≦k<j, ∃xₖ ε g(k) such that xₖRxₖ₊₁. Then (3.11) aRb [symbol] π(b)πₐ εG⁽ⁱ⁻¹⁾ covers a, and other alternate edges of the R-cycle(s) defined by aRb, and those covered by π(b) except one edge of b.

In the event that aRb is composed of two or more consecutive ID edge pairs, there is no true R-cycle, and then the only edge in the “edge-pair” will be covered by the product π(b)πₐ as well as by π(b).

### Length of aRb.

Definition 3.9. For any two edge pairs a, b ε E_{M}, the length, |aRb|=1 if either the R-cycle defined by aRb is of size 4, or a=idᵢ and j−i=1.

Lemma 3.10. The relation R over the set E_{M} is transitive.

Before we can formally define a generating graph, we need to define one more kind of relationship over the generating set E_{M}(n).

### The Disjoint Relationship

Definition 3.11. Any two edge pairs a and b in E_{M} are said to be disjoint if (i) the corresponding edges in the bipartite graph BG are vertex-disjoint, and (ii) aRb is false.

When the disjoint edge pairs a and b belong to two adjacent edge-sets, i.e., a ε g(i) and b ε g(i+1), 1≦i<n, we indicate the relationship as aSb.

### 3.6. Preferred Embodiment: The Generating Graph

The generating models solutions to a given optimization problem by the perfect matchings in the associated bipartite graph. We construct a graph derived from complete bipartite graph K_{n,n} that models the transitive relation R over the generating set E_{M}. This graph is called a generating graph, and will generate all the perfect matchings in K_{n,n}, in a manner similar to generating all the permutations by the generating set of the symmetric group, Sₙ.

Let |aRb| denote the length of the graph cycle in BG=K_{n,n} defined by aRb. Then the generating graph, Γ(n), of a complete bipartite graph K_{n,n} on 2n nodes can be formally defined as

$$Γ ( n ) {=}^{def} ( V , {E}_{R} ⋃ {E}_{S} ) , where \\ V = {E}_{M} = ⋃ g ( i ) , \\ {E}_{R} = \{ {a}_{i} {a}_{j} \vert {a}_{i} {Ra}_{j} , {a}_{i} ∈ g ( i ) , {a}_{j} ∈ g ( j ) , 1 \leq i < j \leq n , \} , \\ where \vert {a}_{i} {Ra}_{j} \vert = 1 , and {E}_{S} = \{ {b}_{i} {b}_{i + 1} \vert {b}_{i} {Sb}_{i + 1} , {b}_{i} ∈ g ( i ) \\ and {b}_{i + 1} ∈ g ( i + 1 ) , 1 \leq i < n \} \qquad ( 3.9 )$$

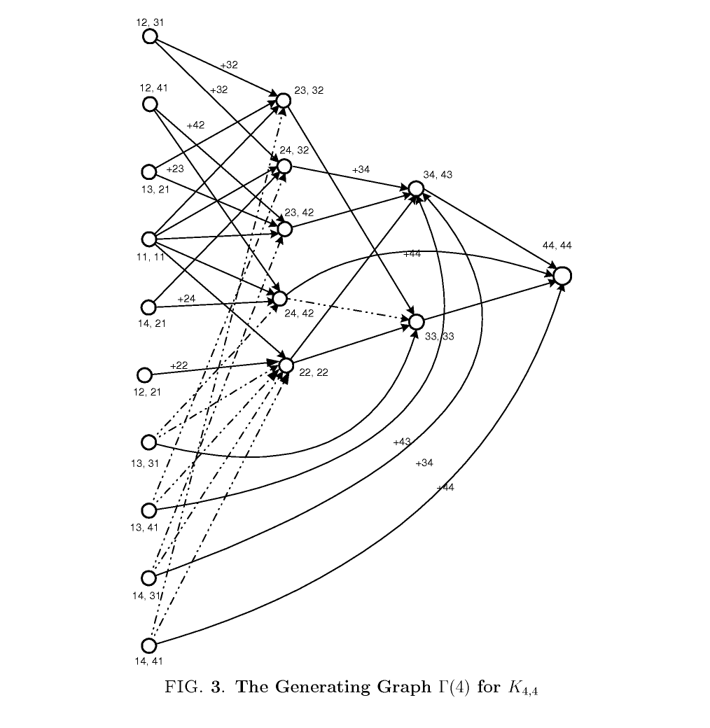

Thus the generating graph is an n-partite directed acyclic graph where the nodes in the partition i are from g(i), 1≦i≦n, representing the various edge pairs at the node pair i in K_{n,n}, and the edges represent either the transitive relation R (by a solid directed line) between the two nodes, or the disjoint relationship between the two nodes (by a dotted directed line) in the adjacent partitions. Each edge is a directed edge from a lower partition node to the higher partition node whenever the associated nodes are related. FIG. 3 shows a generating graph Γ(4) for the complete bipartite graph K_{4,4}.

The edges in E_{R} will be referred to as R-edges. Similarly, the edges in E_{S} will be referred to as S-edges. An R-edge between two nodes that are not in the adjacent partitions will be called a jump edge, whereas those between the adjacent nodes will sometimes be referred to as direct edges. Moreover, for clarity we will always represent a jump edge by a solid curve.

Definition 3.12. An R-path is a path formed by the adjacent R-edges between the two nodes aᵢ, bⱼ ε Γ, j>i such that aᵢRbⱼ.

An R-path in Γ(n) represents the transitive relation R among the nodes in Γ(n).

3.7. Basic Properties of Generating Graph: We now present few basic properties and attributes of the generating graph. These properties will be used in developing various search and counting algorithms.

The R-outdegree of a node a ε Γ is defined as the number of R-edges going out from a. Similarly, the S-outdegree of a node a ε Γ is the number of S-edges going out from a.

Property 3.13. In ever generating graph Γ(n), ∀xᵢ ε g(i), ∃ xⱼ ε g(j) such that xᵢRxⱼ, where 1≦i<j≦n. Similarly, the reverse result is also true—for all xⱼ ε g(j), there exists xᵢ ε g(i), i<j, such that xᵢRxⱼ.

Property 3.14. In ever generating graph Γ(n), ∀(i, j), 1≦i<j≦n, ∃ xᵢ ε g(i) and xⱼ ε g(j), such that xᵢRxⱼ

Property 3.15. Let i and j>i be any two node partitions in Γ(n). Then ∀xᵢ ε g(i), xᵢRxⱼ [symbol] yⱼ ε g(j) such that xᵢ and yⱼ are disjoint, and xᵢRxⱼ is false. Similarly xᵢ and yⱼ being disjoint, and xᵢRxⱼ being false implies [symbol] yⱼ ε g(j) such that xᵢRyⱼ.

Property 3.16. At every node at level i, 1≦i<n, there are ο(n) R-edges reaching either to the adjacent nodes or to the distant nodes. More specifically, the maximum R-outdegree of any node (except for the ID node) at partition i is n−i−1.

Property 3.17. The following attributes of the generating graph for a complete bipartite graph BG on 2n nodes are easy to verify.

Total number of nodes at partition i=|g(i)|=(n−i)²+1, 1≦i≦n (3.12 )

Total number of nodes in Γ(n)=ο(n³) (3.13)

Max. S-outdegree of any node at partition i−(n−i−2)²+1, 1≦i<n−1 (3.14)

Total number of R-edges in Γ(n)=ο(n⁴) (3.15)

Total number of S-edges in Γ(n)=ο(n⁵) (3.16)

Property 3.18. All the R-edges coming from a node in Γ(n) go to the same node partition. Thus either all R-edges coming from a node are direct edges, or all are jump edges.

### OPERATION OF THE INVENTION

In order to describe the operation of the core system, some more concepts are described as follows.

### 3.8. The Edge Requirement

Edge Requirement is a qualifying criteria for a potential solution to exist in the given instance of the bipartite graph.

In general, for any R-edge aRb to exist, one or both of the edges of the edge pair b may not be present in BG′. To indicate this fact every R-edge between two nodes a, b ε Γ(n) is labelled as +e, where e is an edge from the edge pair b, covered by the cycle defined by aRb. This label e+ indicates that the edge e is redundant, or surplus, in forming the product ψ_{b}ψₐ. This property of aRb drives the following definitions.

The Edge Requirement of a node xᵢ ε g(i) in Γ(n) is

$$ER ( {x}_{i} ) {=}^{def} \{ e \vert e ∈ {x}_{i} and e ∉ {BG}^{′} \} \qquad ( 3.17 )$$

### The Surplus Edge, SE(xᵢxⱼ), for an R-edge xᵢxⱼ ε Γ(n) is given by

$$SE ( {x}_{i} {x}_{j} ) {=}^{def} the edge e ∈ {x}_{j} covered by the R \text{-} cycle defined by {x}_{i} {Rx}_{j} \qquad ( 3.18 )$$

The surplus edge for an S-edge is null.

The Edge Requirement ER(p) of an RS-path, p in Γ(n), is the collection of each of the nodes' Edge Requirement that is not satisfied by an R-edge in p. That is,

$$ER ( p ) {=}^{def} {⋃}_{{x}_{i} ∈ p} ER ( {x}_{i} ) - ( \{ SE ( {x}_{j} {x}_{k} ) \vert {x}_{j} , {x}_{k} ∈ p \} ⋂ ( {⋃}_{{x}_{i} ∈ p} ER ( {x}_{i} ) ) ) \qquad ( 3.19 )$$

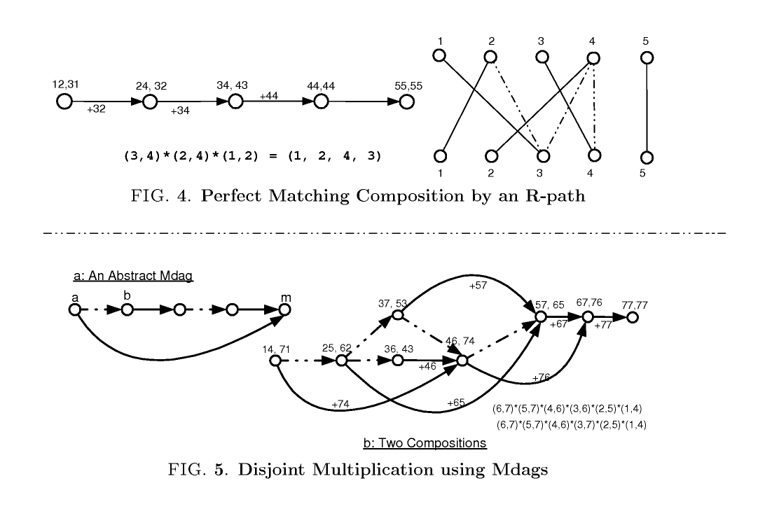

An example of how the Edge Requirements are used in composing a perfect matching is shown above in FIG. 4. The dotted edges in BG indicate they are redundant or surplus. That is, the edges 32, 34 and 44 appear in the composition but are not necessary to form the perfect matching (1, 2, 4, 3).

### 3.9. Multiplication of Disjoint Coset Representatives

Definition 3.19. Let pₐ and p_{b} be two R-paths. Then pₐ and p_{b} are said to be disjoint if and only if for any node pair (x, y), x≠y, x α pₐ, y ε p_{b}, x and y are disjoint.

The following Theorem characterizes the R-paths that implement the multiplication of two disjoint nodes.

Theorem 3.20. The necessary and sufficient condition for the two disjoint nodes a ε g(i), b ε g(i+1) in Γ(n) to be multiplied (i.e., composed as a.b) is the existence of two disjoint R-paths from a and b to a common node c ε g(k), k>i+1.

### 3.9.1. The Multiplying DAG

Definition 3.21. A multiplying directed acyclic graph, denoted as MDG(a, b, m), a ε g(i), b ε g(i+1), m ε g(k), 1≦i<k−1≦n−1, is a pair of two distinguished edges—an S-edge ab defined by aSb, and a jump edge am defined by aRm such that the nodes b and m are either disjoint (cf. Definition 3.11), or are related by R such that the edge am is disjoint with the R-path defined bRm.

A disjoint multiplication using mdags is shown in FIG. 5. The above behavior of mdags motivates the concept of a valid multiplication path in Γ(n).

Valid Multiplication Path. For any arbitrary RS-path a VMP is defined inductively using mdags as follows.

Definition 3.22. An RS-path p=xᵢxᵢ₊₁ . . . xⱼ₋₁xⱼ, xᵣ ε g(r), 1≦i<j≦n of R- and S-edges in Γ(n), is a valid multiplication path, denoted as VMP(i, j), if and only if it satisfies one of the following axioms:
(1) p is an R-path with no jump edges.
(2) p is an S edge.
(3) The path p obtained by incrementing a VMP, p′−xᵢ₊₁xᵢ₊₂ . . . xⱼ, as follows. Let xₜ be a node on p′ such that there exists a valid mdag, MDG(xᵢ, xᵢ₊₁, xₜ), or an R-edge xᵢxᵢ₊₁, if t=i+1. Then p=xᵢxᵢ₊₁xᵢ₊₂ . . . xⱼ is a VMP.

### Complete VMP.

Definition 3.23. A VMP, p=xᵢxᵢ₊₁ . . . xₜ₋₁xₜ in Γ(n), is called a complete VMP (abbr. CVMP) if and only if for every S-edge, (xⱼ, xⱼ₊₁) in p, the associated mdag, MDG(xⱼ, xⱼ₊₁, d), is covered by p, for some d ε g(j+r), r>1.

Property 3.24. A VMP, p=xᵢxᵢ₊₁ . . . xₜ₋₁xₜ in Γ(n), is a complete VMP if it satisfies any one of the following conditions:
(1) p is an R-path with no jump edges.
(2) The path p obtained b incrementing a CVMP, p′=xᵢ₊₁xᵢ₊₂ . . . xⱼ, as follows. Let xₜ be a node on p′ such that there exists a valid mdag, MDG(xᵢ, xᵢ₊₁, xₜ). Then p=xᵢxᵢ₊₁xᵢ₊₂ . . . xⱼ is a CVMP.
(3) p=p₁p₂, where p₁ and p₂ are two CVMPs.

The following Theorem provides gives a group theoretic semantics of a VMP, showing how a VMP represents a product of coset representatives that would multiply any element of the associated subgroup. Further, it shows how that product is represented by a set of matched edges.

Theorem 3.25. Ever CVMP(1, n), p=x₁x₂ . . . xₙ₋₁xₙ in Γ(n), represents a unique permutation π ε Sₙ, and a perfect matching E(π) in BG given by

π=ψₓ_{ₙ}ψₓ_{_{n−1}} . . . ψₓ_{₂}ψₓ_{₁} (3.20)

E(π)={e εxᵢ ε p}−{SE(xⱼxₖ)|xⱼ, xₖ ε p} (3.21)

Lemma 3.26. Let p=x₁X₂ . . . xₙ₋₁xₙ be a CVMP(1, n) in Γ(n). Then ER(p)=Φ [symbol] E(π) is a perfect matching in BG given by (3.20) and (3.21).

Incrementing a VMP. The following Lemma essentially says that one can always find an incrementally larger VMP, VMP(i, n), given VMP(i+1, n), using an additional edge provided by a unique node from g(i). We are not really constructing new paths they are already there in Γ(n).

Lemma 3.27. Ever VMP, p=VMP(i+1, j) in Γ(n), 1≦i<j≦n−2, can always be incremented to another VMP, p′=VMP(i, j).

### Incrementing a Complete VMP.

Lemma 3.28. For each ψ ε Uᵢ (3.5), an CVMP, p=CVMP(i+1, n) in Γ(n), 1≦i≦n−2, can always be incremented to another CVMP, p′=CVMP(i, n), to realize the product πψ, where ψ ε Uᵢ is an coset representative of G⁽ⁱ⁾ in G⁽ⁱ⁻¹⁾, and π ε G⁽ⁱ⁾ is the permutation realized by p.

### Characterization of VMP.

Theorem 3.29. An RS path, p=xᵢxᵢ₊₁ . . . xⱼ₋₁xⱼ, xᵣ ε g(r), 1≦i<j≦n, in Γ(n) is a VMP if and only if for every node pair (xᵣ, xₛ) ε p, i≦r<s≦j, we have either xᵣRxₛ, or xᵣ and xₛ are disjoint (cf. Defn 3.11) in K_{n,n}.

### Qualified Mdags.

Definition 3.30. Let T be a set of nodes containing at the most one node from each of the node partitions between i+1 and m in Γ(n) where 1≦i<m−1≦n−1. Then a qualified mdag, denoted as MG*(xᵢ, xᵢ₊₁, T), represents a subset of all VMPs represented by MDG(xᵢ, xᵢ₊₁, xₘ) such that each VMP covers all the nodes in T.

Thus T can be viewed as a specification for a subset of the VMPs represented by a given mdag.

### Node Connectors.

Definition 3.31. A Node Connector, denoted as nconn(xᵢ, xᵢ₊₁, T), for two adjacent nodes, xᵢ, xᵢ₊₁ ε Γ(n), is either an R-edge (if xᵢRxᵢ₊₁) or a qualified mdag, MG*(xᵢ, xᵢ₊₁, T), (if xᵢSxᵢ₊₁). Note that T associated with an S-edge nconn contains at least one node, i.e., the node xₘ in MDG(xᵢ, xᵢ₊₁, xₘ). The nconn for an R-edge, xᵢRxⱼ can be analogously defined where T may contain the nodes from the adjacent nconn in the preceding partitions.

A VMP, p, is said to cover a node connector, nconn(xᵢ, xᵢ₊₁, T), if p covers xᵢ, xᵢ₊₁ and all the nodes in T.

The following Corollary of Theorem 3.29 specifies the necessary and sufficient conditions for the two adjacent S-edges, and hence the associated nconns to be covered by a VMP.

Corollary 3.32. Let sᵢ=(xᵢ, xᵢ₊₁), and sᵢ₊₁=(xᵢ₊₁, xᵢ₊₂) in Γ(n) be two adjacent S-edges, and MDG(xᵢ xᵢ₊₁, d₁), MDG(xᵢ₊₁, xᵢ₊₂, d₂) be two associated mdags. Then sᵢ and sⱼ are covered by a VMP, if and only f the following two conditions hold true:
(1) the two nodes xᵢ and xᵢ₊₂ are either disjoint or related by R;
(2) either d₁=d₂, and then the R-edges xᵢd₁ and xᵢ₊₁d₁ must be disjoint; or d₁ and d₂ are either disjoint or related by R.

### The Transitive Relation μ.

Definition 3.33. Let mₐ=nconn(xᵢ, xᵢ₊₁, Tₐ) and m_{b} nconn(xⱼ, xⱼ₊₁, T_{b}), 1≦i<j≦n, be the two node connectors for the two pairs of adjacent nodes, (xᵢ, xᵢ₊₁) and (xⱼ, xⱼ₊₁) respectively. Then mₐ is said to be related to m_{b} by the relation μ, denoted as mₐμm_{b}, if and only if all VMPs that cover m_{b} also cover mₐ.

Lemma 3.34. The relation μ is transitive over the set of Node Connectors in the generating graph Γ(n) for K_{n,n}.

3.9.2. Composing a Perfect Matching from a CVMP. The next Lemma 3.35 states that the set of all unique CVMPs in the generating graph Γ(n) is precisely the set of n! perfect matchings in K_{n,n}.

Lemma 3.35. A unique CVMP(1, n) in Γ(n) [symbol] a unique perfect matching in BG=K_{n,n}. Thus the generating graph Γ(n) for K_{n,n} correctly enumerates all the n! perfect matchings in K_{n,n} by its n! unique CVMPs, CVMP(1, n).

TABLE 1
Composing all the Perfect Matchings in Γ(3)

| | | Perfect |
|---|---|---|
| CVMP(1, 3) = x₁ · x₂ · x₃ | Permutation: ψₓ₃ψₓ₂ψₓ₁ | Matching |
| (11, 11) · (22, 22) · (33, 33) | I * I * I = I | {11, 22, 33} |
| (11, 11) · (23, 31) · (33, 33) | I * (2, 3) * I = (2, 3) | {11, 23, 32} |
| (12, 21) · (22, 22) · (33, 33) | I * I * (1, 2) = (1, 2) | {12, 21, 33} |
| (12, 31) · (23, 32) · (33, 33) | I * (2, 3) * (1, 2) = (1, 2, 3) | {12, 23, 31} |
| (13, 31) · (22, 22) · (33, 33) | I * I * (1, 3) = (1, 3) | {13, 22, 31} |
| (13, 21) · (23, 32) · (33, 33) | I * (2, 3) * (1, 3) = (1, 3, 2) | {13, 21, 32} |

3.10. Preferred Embodiment: Algorithm for Search and Counting of Perfect Matchings. We saw in Lemma 3.35 above all the perfect matchings in K_{n,n} can be counted by counting all the unique CVMP(1, n) in Γ(n). We now show how the same technique for counting the perfect matchings can be used for any bipartite graph, i.e., not necessarily a complete one. We present an NC algorithm for search and counting of perfect matchings in any arbitrary bipartite graph. Note that the counting problem for perfect matchings in a bipartite graph is known to be #P-complete [Val79].

Counting the ER-Satisfied CVMPs. Warshall's algorithm provides a foundation for counting all the paths between any two nodes in a graph. The algorithm makes use of the transitivity of paths in order to join the two sets of paths. Counting all the CVMPs in a generating graph makes use of this basic concept where the nconns take the place of nodes.

Let P(a, b) be the set of VMPs between two common nconns a and b. By transitivity, for each VMP p ε P(a, b), and for each VMP q ε P(b, c) there exists a VMP pq ε P(a, b) which covers b. That is, the corresponding permutation πₚ must be able to multiply each permutation π_{q} to produce π_{q}πₚ corresponding to the CVMP, pq. The following Lemma captures a concatenation behavior which is driven by the underlying permutation multiplication mechanism.

Lemma 3.36. Let and P(a, b) and P(b, c) be two sets of VMPs between two common nconns a and b, and b and c, at three distinct node partitions in Γ(n). Let the composition P(a, b)×P(b, c) is performed leading to a CVMP. In order that P(b, c) leads to a set of countable CVMPs, the cardinality of each partition k, i<k<j, in P(b, c) must be either one, or each xₖ has a common edge in K_{n,n} whenever ER(xₖ)≠Φ, for any node xₖ ε P(b, c).

### The Data Structures.

We present the following data structures for storing the generating graph and manipulating the VMPs within the generating graph.

### Representation of the Generating Graph.

The generating graph Γ(n) is represented by an adjacency matrix, GGM, of dimension |E_{M}|×|E_{M}|, where |Eₘ| is the total number of nodes in Γ(n). This matrix specifies the presence of all the R and S edges in Γ(n). Clearly it is of size ο(n³×n³). Each element of aᵢⱼ of GGM is an ordered pair, (<edge present >, <edge type >), where the first element in the ordered pair is a boolean with value 1 indicating an R or S edge between the nodes i and j, and 0 otherwise. The second element is 1 if it is an R edge and 0 if it is an S edge.

### Representation of the VMPs.

First we present a data structure for representing a set of VMP between two nodes.

Let MDAGₛ=MDG(aᵢ, xᵢ₊₁, dⱼ) and MDAGₜ=MDG(bⱼ, zⱼ₊₁, dₖ) be the two mdags at the nodes aᵢ and bⱼ in the node partitions i and j respectively.

```
VMPSet(aᵢ,aⱼ) =
    Struct{
        MDAGs // the ”source” mdag,
        MDAGt // the ”terminal” mdag,
        NODE_ARRAY Array of {(multOK,node)},
        // array of nodes with a boolean qualifier multOK
        SE_ARRAY Array of{(SE, jumpNode)}// array of jump edges,
        ER// the edge Requirements for this VMP,
        CountOfVMP// total VMPs covering MDAGs and MDAGt
        }
```

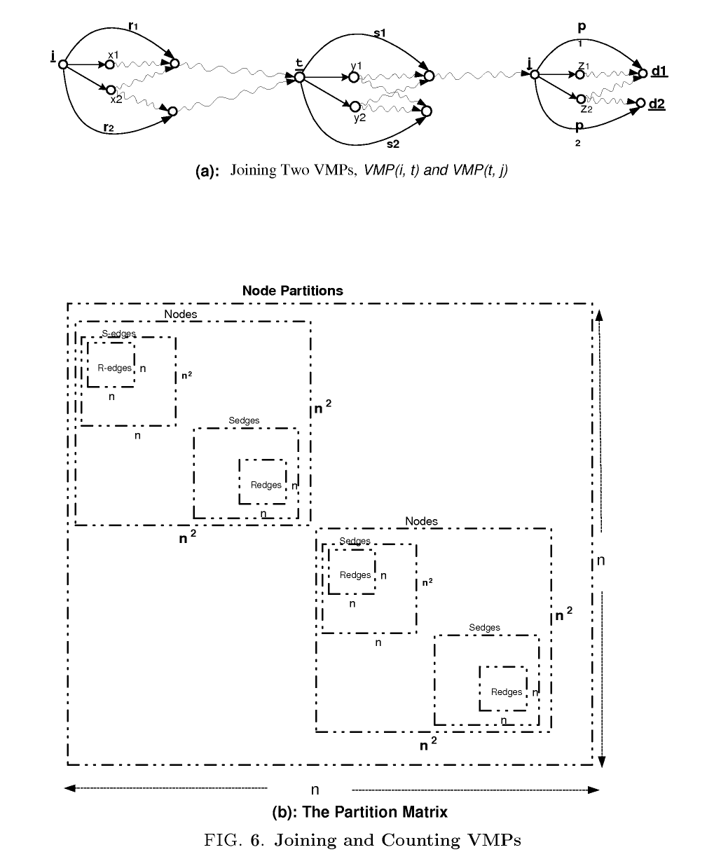

In what follows we describe a matrix structure for representing all the VMPs in a generating graph described by GGM. Referring to FIG. 6 we have three adjacency matrices that together specify all the VMPs, VMP(i, j) between the nodes aᵢ and aⱼ as follows:
PT_M: It is an n×n “adjacency” matrix of the n node partitions in Γ(n). Each element matrix, PT_M[i, j] refers to the nodes in the i and j partitions of Γ(n).
NODE_M: It is an ο(n²)×ο(n²) adjacency matrix of all the adjacent node pairs (aᵢ, aⱼ) that induce mdag pairs (mᵢ, mⱼ) such that there is a path VMP(i, j) covering these two mdags in two distinct partitions i and j. For every (i, j) ε {1, 2, . . . , |E_{M}|}×{1, 2, . . . , |E_{M}|} the entry Mᵢⱼ in NODE_M contains a family of VMPs, VMP set(aᵢ, aⱼ), represented by another matrix SEDGE_M, or an empty entry Φ if no such pair exists.
SEDGE_M: It is an ο(n²)×ο(n²) adjacency matrix of the adjacent S-edge pairs (aᵢxᵢ₊₁, bⱼzⱼ₊₁) which induce a family of adjacent mdag pairs (mᵢ, mⱼ).
REDGE_M: It is an n×n adjacency matrix of the jump edge pairs (aᵢdⱼ, bⱼdₖ) corresponding to the the mdag pair (mᵢ, mⱼ).
   Now these matrices are hierarchically related and specify a VMP, VMP(i, j), as follows. Let M−[X] denote that the matrix M contains elements of type X.

```
    PT_M = [NODE_M],
  NODE_M = [SEDGE_M],
SEDGE_M = [REDGE_M], and
REDGE_M = [VMPSet(aᵢ,aⱼ)]
```

### Outline of the Algorithm.

We will implement essentially a transitive closure of the matrix REDGE_M by iteratively computing REDGE_M*REDGE_M, ο(log n) times, and thus providing all the CVMPs, CVMP(1, n) present in the given generating graph.

Incrementally larger VMPs are found by the transitivity of the nconns. Let mᵢ, mₜ and mⱼ be three nconns such that two VMPs, VMP(i, t) and VMP(t, j) cover the nconn pairs (mᵢ, mₜ) and (mₜ, mⱼ), satisfying mᵢμmₜ, and mₜμmⱼ. Then by the transitivity of the relation μ, mᵢμmⱼ gives the resulting VMP, VMP(i, j). The VM Set contains the data structure to capture the ER and hence to satisfy the condition of Lemma 3.36.

### Initialization of all the Matrices.

(1) Matrix GGM: Each entry in GGM is initialized indicating the presence of each R/S edge, edge type and the ER of that edge.
(2) Matrix PT_M, NODE_M, SEDGE_M: This effectively involves initialization of all its element matrices.
(3) Matrix REDGE_M: Each entry is initialized with VMP Set(aᵢ, aᵢ₊₁) for all i ε {1, 2, . . . , n−1}.

### Joining Two VMPs.

The following algorithm describes joining two VMPs as suggested by Lemma 3.36. It is easy to see that the time complexity of Procedure Join VMP( ) is ο(n).

Procedure 1 JoinVMP (vmpSet1(s,x), vmpSet2(x,t))

| | |
|---|---|
| 1: | vmp(s,t) [symbol] Φ; |
| 2: | mdagS [symbol] get the source mdag from vmpSet1 |
| 3: | mdagT [symbol] get the terminal mdag from vmpSet2 |
| 4: | if (mdagS μmdagT) then |
| 5: | if (SE_ARRAY(vmpSet1) can multiply |
| | NODE_ARRAY(vmpSet2)) then |
| 6: | vmp(s,t) [symbol] vmpSet1 + vmpSet2;{concatenate |
| | vmpSet1 and vmpSet2} |
| 7: | update ER(vmp) using SE_ARRAY(vmpSet1); |
| 8: | CountOfVmpvmp) [symbol] CountOfVmp(vmpSet1) * |
| | CountOfVmp(vmpSet2) |
| 9: | return vmp |
| 10: | end if |
| 11: | end if |

### VMP Length Doubling.

The family of VMPs given by the matrix PT_M can be doubled in its lengths by the following algorithm:

Procedure 2 VmpLengthDoubling(PT_M,GGM)

| | |
|---|---|
| 1: | Find all the n node partitions, PT from GGM; {For each partition pair (i,j), a new |
| | set of larger VMPs will be constructed} |
| 2: | for all (i,j) ε {1,2,...,n−2} × {i+1,i+2,...,n−1} do |
| 3: | for all m ε {m\|i < m < j} do |
| 4: | if ( ∃PT[m], i < m < j, such that PT_[i,j] == Φ&&PT_M[i,m] ≠ Φ ≠ |
| | PT_M[m,j]) then |
| 5: | for all (aₛ,aₜ) ε PT[i] × PT[j] do |
| 6: | for all vmpSet(aₛ,aₜ) ε NODE_M[s,t] do |
| 7: | {effectively computing the product NODE_M * NODE_M} |
| 8: | vmp [symbol] Φ {vmp is the set of all VMP(s,t)}; |
| 9: | vmpTemp [symbol] Φ |
| 10: | for all x ε PT[m] do |
| 11: | er [symbol] Φ; |
| 12: | vmpTemp [symbol] JoinVMP(vmpSet(s,x),vmpSet(x,t)); |
| 13: | if ((vmp≠Φ) and (er = ER(vmpTemp)) ) then |
| 14: | vmp [symbol] vmp∪vmpTemp; { add new vmp only if the ER condition is |
| | satisfied} |
| 15: | CountOfVmp(vmp) [symbol] CountOfVmp(vmp) + |
| | CountOfVmp(vmpTemp) |
| 16: | else if (vmp=Φ) then |
| 17: | er [symbol] ER(vmpTemp); |
| 18: | vmp [symbol] vmpTemp |
| 19: | end if |
| 20: | copy vmp into the appropriate location in [REDGE_M] |
| 21: | end for |
| 22: | end for |
| 23: | end for |
| 24: | end if |
| 25: | end for |
| 26: | end for |

### Counting all the CVMPs

The above algorithm will produce VMPs of length up to twice of what were available originally in REDGE_M. Iteration over ┌log(n)┐ steps will count all CVMPs, CVMP(1, n), with one such CVMP fully specified.

The Time Complexity of Search and Counting. The innermost For loop at line 10 in Procedure VmpLengthDoubling( ) iterates over ο(n²) steps each having the time complexity of ο(n) resulting from the lines at 12 to 18.
The For loop at line 6 is iterated ο(n⁶) times,
the For loop at line 5, ο(n⁴) times,
the For loop at line 3, ο(n) times,
and the For loop at line 2, ο(n²) times.
   All together this gives a total time complexity of ο(n¹⁶). Note that this is much better than the complexity of the product PT_M*PT_M which would be ο(n¹⁸).

### 3.11. Hardware Lookup Table: Speedup by Pre-Computed Structures

The matrix multiplication in Procedure 2 is mostly independent of the input data but depends only the problem size parameter, n. That is all the paths, the VMPs, in a generating graph are fixed for a given n once computed. The only input data that is needed to compute CVMP(1, n) with ER=Φ is the ER of various paths which depends on the given instance of the bipartite graph. This property of the computation can be exploited to solve all problems whose size will be less than or equal to a given size n, and thus reducing the complexity by a polynomial factor. Note that a generating graph Γ(n) includes all generating graphs of size less than n.

One such strategy would be to pre-compute all the ┌(log n)┐ iterations of Procedure 2 on PT_M, and keep them in such a form that would allow the ER computation for all the path segments, that is, paths of length 1, 2, 3, . . . , n. This would mean that at any instant the total number of VMPs would not be more than ο(n⁶), each requiring a concatenation with a known set of VMPs with only ο(n) complexity. Thus reducing the total time complexity to ο(n¹³). Making further refinements in the data structure, e.g., using adjacency lists instead of a matrix can further improve the performance by as much as a factor ο(n).

### Media for the Lookup Table.

The table described above can be realized with a wide range of technologies. These technologies include from a simple relational database to ASICs and ROMs.

### 3.12. Hardware Scaling of the Generating Graph

A generating graph Γ(n+1) can be built from Γ(n) by adding ο(n²) nodes and ο(n⁴) edges. This property can be used to build scalable chips for the generating graphs as well as CVMP computation engines.

### Parallelization—The NC Algorithm.

It is easy to see that all the steps in both the Procedures (1) and (2) are naturally parallelizeable. and so are all the initializations of the associated data structures because the matrix product and sum both are in NC. And therefore, the above algorithm is an NC algorithm with a processor complexity of ο(n¹⁸) on a CRCW PRAM. The implication of the NC algorithm is that once the VLSI or other computer hardware technology advances to the stage that will alow ο(n¹⁸) processors to be integrated on a single chip or a (mother) board, the execution time of all the search and counting problems can be reduced to a practical limit. Further more, even long before then the NC algorithm effectively provides a linear speedup for a fixed problem size n. Thus doubling the number of processors for a fixed n will always result into cutting the execution time to half.

### 3.13. Application to Other NP-Hard and Optimization Problems

This can be achieved by transforming every such (NP-hard) problem to a perfect matching problem. The Hamiltonian Circuit search is an NP-complete problem, and the corresponding counting problem is #P-complete [GJ79]. We present an NC-reduction from Hamiltonian Circuit to Perfect Matching that will prove that search and counting of Hamiltonian Circuits is also in [symbol] , and hence in [symbol] . And thus it will be proven that # [symbol] − [symbol] .

### NC-Reduction: Hamiltonian Circuit to Perfect Matching

We now show how a Hamiltonian Circuit problem can be transformed to an instance of a special kind of perfect matching problem, where all the perfect matchings represent permutation cycles of length n.

Let the graph HC−(Vₕ, Eₕ) be an instance of the HC problem of size n, where |Vₕ|=n, and each node in Vₕ is numbered from Ω={1, 2, . . . , n}. Then it is easy to see that a Hamiltonian Circuit in HC is a unique permutation π ε Sₙ with the property that the length of the permutation cycle is n.

We can construct a bipartite graph BG=(V ∪ W, E) on 2n nodes from HC by the following NC algorithm. Let the nodes in V and W both be labelled from Ω.

### Algorithm:

Procedure 3 NC-ReductionHC2PM(HC)

E ← Φ
for all (vᵢ,vⱼ) ε Eₕ do
E ← E ∪ {vᵢwⱼ,vⱼwᵢ}
end for

Thus the edge set E of the derived bipartite graph BG is:

E=∪{vᵢwⱼ, vⱼwᵢ|vᵢvⱼ ε Eₕ}.

Clearly the above construction of BG from HC is in NC, using ο(1) time and ο(|Eₕ|) processors on a CRCW PRAM.

Lemma 3.37. The problem of search and counting of Hamiltonian Circuits in a graph HC is NC-reducible to the search and counting of perfect matchings in a bipartite graph BG which realizes precisely the permutations representing the Hamiltonian Circuits in HC.

The proof of the above lemma is based on the following property of CVMPs:

Property 3.38. A permutation cycle π ε Sₙ is of length less than n iff the corresponding CVMP in Γ(n) contains ID nodes in one or more partitions, 1, 2, . . . , n−1.

### Application to the Satisfiability (SAT) Problem.

Since SAT is reducible to Hamiltonian Circuit [GJ79], clearly this NP-complete problem (along with all others) can be solved not only in polynomial sequential time but also in polylogarithmic parallel (NC) time whenever the reduction also is in NC. The SAT solution has applications to many combinational circuit testing problems.

### Application to Graph Isomorphism.

Definition 3.39. Let X=(V, E) and Y=(V′, E′) be two graphs with |V|=|V′|. Then X and Y are said to be isomorphic if there exists a permutation π: V→V′ such that (u, v) ε E [symbol] (u^{π}, v^{π}) ε E′.

Definition 3.40. For any two nodes u and v in a graph X=(V, E), (u, v) will be called a black edge if (u, v) ε E. Otherwise it will be referred to as a white edge.

### Another View of Isomorphism

The two isomorphic graphs, X and Y, can be viewed to be connected by a virtual bipartite graph ISOBG=(V(X), V(Y), E₁={(u, u^{π})}) such that for any two “matched edges” (vᵢwᵣ, vⱼwₛ) in E₁(π), the two node pairs, (vᵢ, vⱼ) and (wᵣ, wₛ) in X and Y, connected by these matched edges, represent either two white edges, or two black edges in X and Y respectively. Further, note that for any potential isomorphism between two black (white) edge pairs (vᵢ, vⱼ) and (wᵣ, wₛ), we have exactly two mutually exclusive choices of matched edges, viz., (vᵢwᵣ, vⱼwₛ) and (vᵢwₛ, vⱼwᵣ). This stated in the following Lemma, and will be sued to determine the ER of any VMP in ISOBG.

Lemma 3.41. Let e(X)=(vᵢ, vⱼ) and e(Y)=(wᵣ, wₛ) be two matched edge pairs in X and Y respectively. Then there are exactly two mutually exclusive choices of matched edges in ISOBG, viz., (vᵢwᵣ, vⱼwₛ) or (vᵢwₛ, vⱼwᵣ).

The following Lemma provides a characterization of the n−1 black and white edge pairs that are sufficient to specify an isomorphism between the two isomorphic graphs.

Lemma 3.42. Let X and Y be two isomorphic graphs. Then for every isomorphism π: V(X)→V(Y) between X and Y, exactly n−1 black and white edge pairs (e_{X}, e_{Y}), e_{X} ε X, e_{Y} ε Y are needed to specify π.

The Edge Requirements (ER) of a CVMP that would represent an isomorphism between X and Y is evaluated by the following Lemma:

Lemma 3.43. Let the three nodes (a, b, c) in X be mapped to (x, y, z) in Y under some isomorphism π ε Sₙ. Then,

(a, b, c) defines two adjacent edges [symbol] (x, y, z) defines two adjacent edges

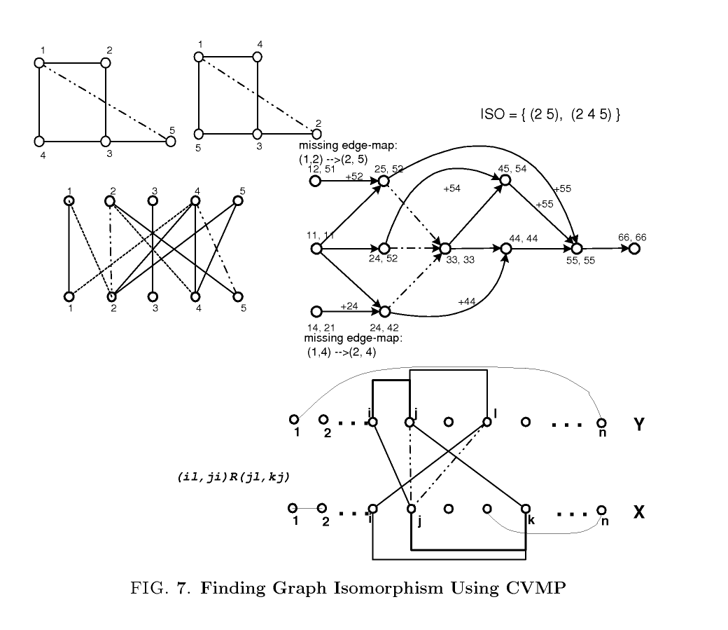

Following the labeling notation for the two partitions of the vertices in K_{n,n}, we can assume that V(X) and V(Y) nodes are also labeled from {1, 2, . . . , n}. An example of this correlation is shown in [FIG. 7].

Procedure 4 Isomorphism (X, Y)

1: Find a π_{CVMP(1,n)} using Algorithm 2, determining the ER by Lemmas
3.43 and 3.42.
$2 \text{:} for all ( \begin{matrix}n \\ 2\end{matrix} ) edges in X do$

| 3: | validate: π_{CVMP(1,n)}: V → V′ such that (u,v) ε E(X) [symbol] |
|---|---|
| | (u^{π}, v^{π}) ε E(Y). |

4: end for

### Time Complexity.

T(Isomorphism)=T(CVMP(1, n))+ο(n²)=ο(n¹⁶)

1. A Solution Generating system for solving combinatorial optimization problems using polynomial time sequential and poly-logarithmic time parallel (NC) algorithms. It comprises of:
(a) a complete bipartite graph BG on 2n nodes, where n is a problem size parameter,
(b) a Generating Set E_{M}(n) derived from said bipartite graph BG,
(c) a Generating Graph Γ(n) defined by the transitive relation over said generating set E_{M}(n),
(d) a Valid Multiplication Path (VMP) in said generating graph which represents a potential solution to the given combinatorial optimization problem,
(e) a qualifying set called Edge Requirements (ER) for said VMP, representing a condition for the existence of a solution to the given optimization problem,
whereby an NP-hard problem, viz., Counting the Perfect Matchings in a Bipartite Graph (AKA Permanent of a 0-1 matrix), can be computed efficiently in a tractable manner, i.e., using only polynomial sequential time or polylogarithmic parallel time.

2. Application of claim (1), to derive Polynomial time Sequential algorithms as well as Polylogarithmic time Parallel (NC) algorithms for a large class of NP-complete, NP-hard and “intermediate complexity” NP problems, using parallel processing systems with considerable speedup. Such problems include, Encryption, combinational circuit testing for VLSI's, VLSI layout, Scheduling problems, and many others.

3. Application of claim (1) to derive Polynomial time Sequential algorithm and Polylog time Parallel (NC) algorithms for graph Isomorphism.

4. A hardware (such as an EPROM or ROM chip) Lookup Table for a given problem of size n to speedup the computation in claim (1) by a dramatic factor, ο(n³). Said Lookup Table will be independent of the problem instance (i.e., the input data) and will speed up the computation of a said VMP and hence that of a potential solution.

5. A Scaling scheme, for said generating graph in claim (1), in hardware (such as a ROM VLSI) for larger or smaller size problems. Said generating graph in claim (1) has a natural structure for scaling itself in either directions. For example, a graph Γ(n) will allow all search and counting problems of size m≦n also be computed. Further, the larger (said) generating graphs can be constructed from the smaller ones.
